(19) United States
(12) Patent Application Publication
(10) Pub. No.: US 2015/0079572 A1
(43) Pub. Date: Mar. 19, 2015

(54) Teacher and student digital porfolio evaluation system for annual professional performance review

(71) Applicant: Izzet Mergen, Sayville, NY (US)

(72) Inventor: Izzet Mergen, Sayville, NY (US)

(21) Appl. No.: 13/987,909

(22) Filed: Sep. 14, 2013

(51) Int. Cl. G09B 5/06

(52) U.S. Cl. CPC G09B 5/065
USPC 434/308

(57) ABSTRACT

A method for enabling a teacher and student digital portfolio evaluation system, having a video camera for gathering audio and video data of at least one student's performance, a computer, laptop or tablet for receiving and storing that data, and data migration means for converting said data into HEDI scores, representing forty (40) points of a teacher's one hundred (100) point evaluation in accordance with the Annual Professional Performance Review. Twenty (20) of said forty (40) points represents growth, and said data migration means follows the algorithm:
Pr=PreTest
Po=Post Test
g=Po−Pr
g=½(100−g).

### FIELD OF THE INVENTION

The present invention relates to the field of teacher and student evaluation systems, and more specifically, to systems for integrating full media data and files (including graphics, video and audio) in a method that enables migration to a data format satisfying state and federal APPR (Annual Professional Performance Review) requirements.

### BACKGROUND OF THE INVENTION

Inventor incorporates by reference his full Dissertation which is annexed hereto.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

The foregoing objects and other objects of the invention are achieved through a method for enabling a teacher and student digital portfolio evaluation system, having a video camera for gathering audio and video data of at least one student's performance, a computer, laptop or tablet for receiving and storing that data, and data migration means for converting said data into HEDI scores, representing forty (40) points of a teacher's one hundred (100) point evaluation in accordance with the Annual Professional Performance Review. Twenty (20) of said forty (40) points represents growth, and said data migration means follows the algorithm:
Pr=PreTest
Po=Post Test
g=Po−Pr
g=½(100−g).

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein similar reference characters denote similar elements through the several views:

FIG. 1 is a systems view of the overall elements of the inventive system; and

FIG. 2 is a breakout of the steps of data migration upon data gathering or acquisition, as shown in FIG. 1.

### DETAILED DESCRIPTION OF THE PREFERRED EMBODIMENTS

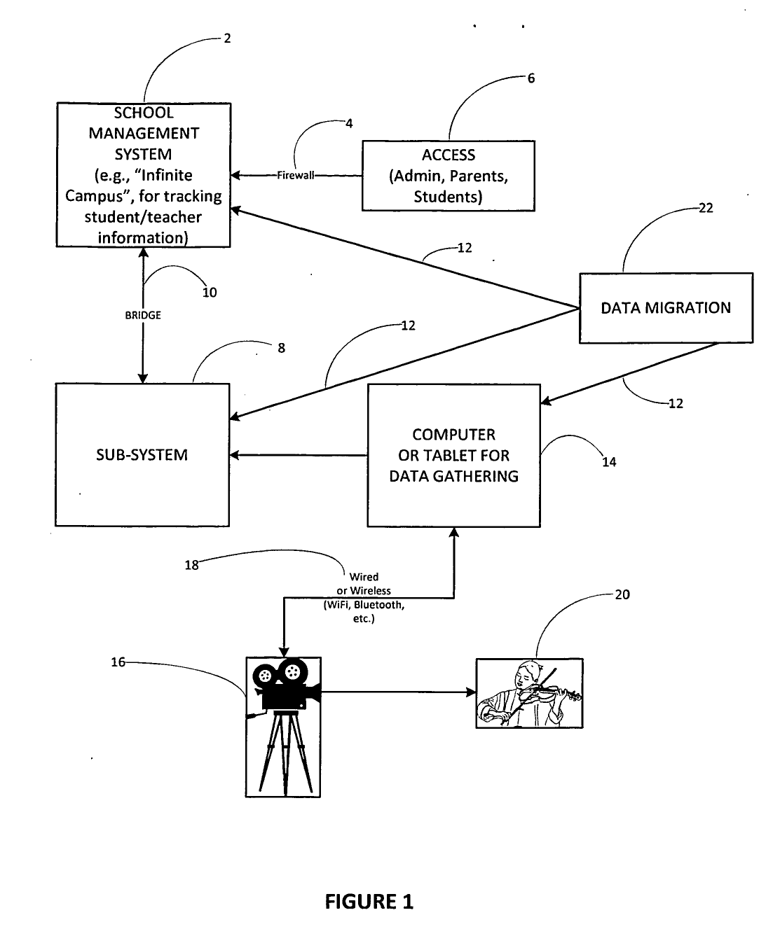

In accordance with the subject invention, FIG. 1 shows an overall systems design of the subject invention. School Management System 2 comprises a pre-existing system that a school has adopted, including, by way of example, “Infinite Campus” which enables the private storing of student and teacher data, and the accessing of the same. In particular, by way of firewall 4, access is had at step 6 by administrators, parents and students. In this respect, such access, via firewall 4 is limited to read only for parents and students, with administrative rights to review and modify relegated to administrators.

In FIG. 1, media device 16 is shown, although any of a series of known media devices may be employed, including digital cameras, recording devices and the like that can observe and record the performance by students 20 of, in this example, musical instruments. It should be understood that the subject inventive system, method and apparatus are primarily used for the performance disciplines (e.g., art, music, foreign language, dance, theater and physical education) where the typical methods of accounting for performance and a students' education (and improvement) have proven heretofore inadequate. For example, the use of grading systems that are based upon a numerical scale and a series of questions (with multiple choice styled answers) are hardly relevant to a students' improved abilities to play, e.g., a Mozart piece.

The output from media device 16 is either hardwired or wirelessly connected (WiFI, bluetooth or other) to a computer 14 for data gathering. It should be understood that computer 14 can comprise a cell phone or iPad (with media device 16 incorporated therein), or notebook, laptop or desktop, provided it has sufficient components to handle the scope of the media content and operational data acquisition, mapping, transformations and migration.

Upon data acquisition by computer 14, data migration at step 22 occurs. It should be appreciated that data migration at step 22 can occur either within computer 14, or in a sub-system 8 or, for that matter as part of school management system 2 (all as shown by arrows 12). Where a sub-system 8 is employed, data migration occurs therein and can comprise an additional computer with a bridge 10 to the School management system. Bridge 10 can be data files associated with a known file format that maps to the school management system 2, as in, e.g., an Excel spreadsheet accommodating media files in association with student and/or teacher identification.

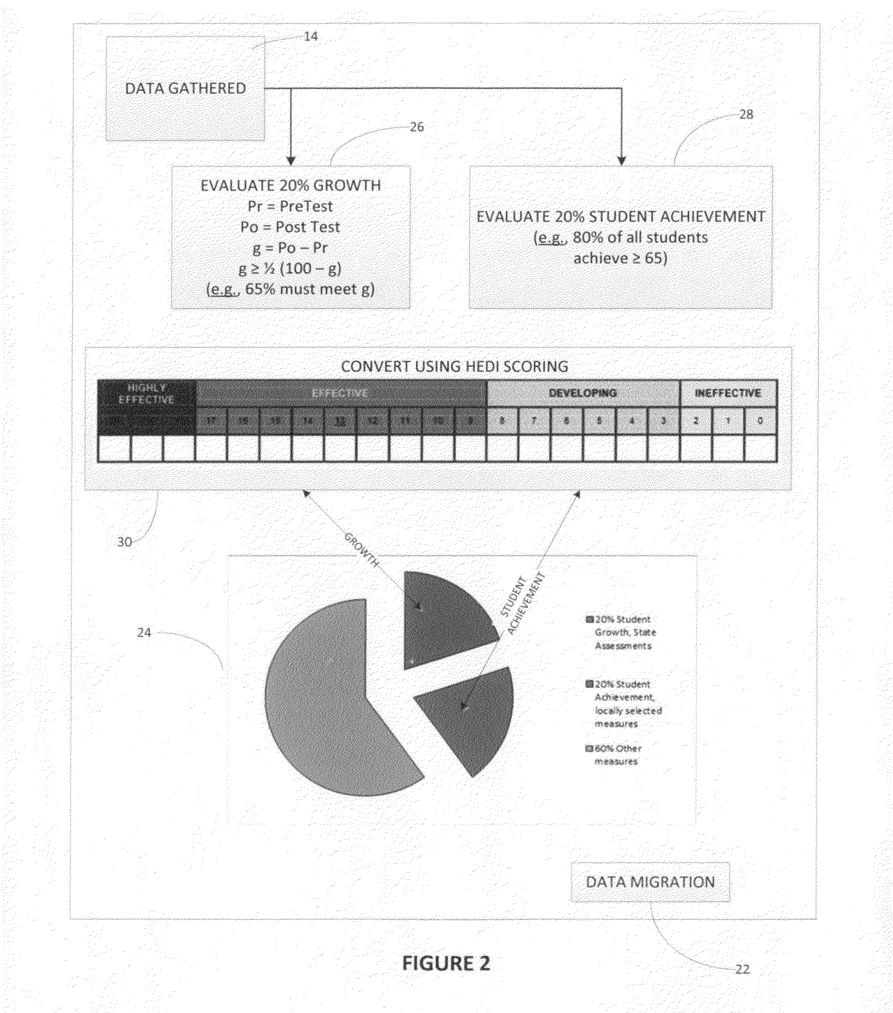

FIG. 2 shows greater detail of the data migration step 22, wherein data gathered at step 14 isa converted using HEDI scoring into the 20% growth component and 20% student achievement component of the overall Annual Professional Performance Review standard. In particular, by having media files showing student performance linked to the HEDI scoring outcome, much of the otherwise arbitrary and unverifiable nature of heretofore utilized student evaluations (and from that, teacher evaluations) are eliminated, for student performance is now verified by observing the media contemporaneously recorded with the process of evaluation of the subject student. For example, in evaluating each students growth, which represents 20% of the APPR score, the following formula is employed, verified upon actual observation:
Pr=PreTest
Po=Post Test
g=Po−Pr
g=½(100−g).
   The score from HEDI is obtained by, e.g., determining that a minimum of 65% must meet “g” and converting the same, per step 26. Likewise, 20% representing student achievement can be determined by setting a standard at 80% of all students achieving greater than 65, as shown in step 28.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

I claim:

1. A method for enabling a teacher and student digital portfolio evaluation system, comprising:
(a) media gathering means for gathering audio and video data of at least one student's performance;
(b) computer means for receiving and storing said data; and
(c) data migration means for converting said data into HEDI scores, representing forty (40) points of a teacher's one hundred (100) point evaluation in accordance with the Annual Professional Performance Review.

2. The method of claim 1, wherein twenty (20) of said forty (40) points represents growth, and said data migration means follows the algorithm:
Pr=PreTest
Po=Post Test
g=Po−Pr
g=½(100−g).
